(19) United States
(12) Patent Application Publication
(10) Pub. No.: US 2026/0163304 A1
(43) Pub. Date: Jun. 11, 2026

(54) Connector Assembly and Major Connector Thereof

(71) Applicants: Dongguan Tarng Yu Electronics Co., Ltd., Dongguan City (CN); Tarng Yu Enterprise co., ltd., New Taipei City (TW)

(72) Inventors: YING-CHUNG CHEN, New Taipei City (TW); MU-JUNG HUANG, New Taipei City (TW)

(21) Appl. No.: 19/179,287

(22) Filed: Apr. 15, 2025

(30) Foreign Application Priority Data
Apr. 15, 2024 (TW) 113203725

(51) Int. Cl. H01R 13/64; H01R 13/04; H01R 13/24; H01R 13/627

(52) U.S. Cl. CPC H01R 13/64; H01R 13/04; H01R 13/24; H01R 13/6278

(57) ABSTRACT

A connector assembly and a major connector thereof, wherein the connector assembly further comprises a minor connector that can be joined with the major connector, and the connector assembly is provided with a trigger component that can trigger power or signal transmission only when the major connector and the minor connector are properly joined. In this way, it solves the technical problem where multiple connectors belonging to a conventional connector assembly fail to transmit power or signals effectively due to improper joining, thereby enabling the connector assembly of the present application to timely transmit power or signals and function as expected in electronic devices.

### CROSS-REFERENCE TO RELATED APPLICATIONS

This application claims the priority of Republic of China Patent Application No. 113203725 filed on Apr. 15, 2024, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to a connector assembly and a major connector thereof that can transmit power or signals only when properly joined in place.

### Descriptions of the Related Art

Conventionally, it is often necessary to configure a connector assembly in electronic devices. Generally, a connector assembly comprises a plurality of connectors, which can be joined to transmit power or signals. However, in practical implementations, the plurality of connectors belonging to the connector assembly may fail to effectively transmit power or signals due to improper joining, resulting in the connector assembly not performing as expected in electronic devices.

Based on the foregoing, how to prevent the plurality of connectors belonging to the connector assembly from transmitting power or signals before being properly joined in place has become an urgent issue for those skilled in the relevant technical field.

### SUMMARY OF THE INVENTION

In view of the drawbacks of the prior art mentioned above, the present application provides an major connector, comprising: the major connector being configured to be equipped with a power supply module and a trigger module, wherein the trigger module is configured to trigger the power supply module, causing the power supply module to provide a first side terminal power and a second side terminal power, and the major connector is configured to be equipped with a minor connector, wherein the minor connector comprises a minor power terminal set and a minor trigger component, and the minor power terminal set comprises a first side minor power terminal and a second side minor power terminal, and the major connector comprises: a major power terminal set, which is electrically connected to the power supply module, and the major power terminal set comprises a first side major power terminal and a second side major power terminal, and the first side major power terminal comprises a first side major power terminal joining structure, and the second side major power terminal respectively comprises a second side major power terminal joining structure, wherein the first side major power terminal joining structure is joined with the first side minor power terminal, and the second side major power terminal joining structure is joined with the second side minor power terminal; a major trigger component set, which is electrically connected to the trigger module, and the major trigger component set comprises a first side major trigger component and a second side major trigger component, and the first side major trigger component comprises a first side major trigger component joining structure, and the second side major trigger component comprises a second side major trigger component joining structure, wherein the first side major trigger component joining structure and the second side major trigger component joining structure are respectively joined with the minor trigger component; and a major connector body, the two sides of the major connector body are respectively a first major connector body side and a second major connector body side, and the major connector body is respectively mated with the major power terminal set and the major trigger component set to respectively position the first side major power terminal, the second side major power terminal, the first side major trigger component, and the second side major trigger component, to allow the first side major power terminal joining structure to be located at the first major connector body side, and to allow the second side major power terminal joining structure to be located at the second major connector body side, furthermore, enabling the first side major trigger component joining structure to be located at the first major connector body side, and enabling the second side major trigger component joining structure to be located at and the second major connector body side; wherein, the minor connector is configured to join the major connector, so that the first side minor power terminal joins the first side major power terminal joining structure, and the second side minor power terminal joins the second side major power terminal joining structure, allowing the first side major power terminal and the first side minor power terminal to be electrically connected, and the second side major power terminal and the second side minor power terminal to be electrically connected, additionally, the first side major trigger component joining structure and the second side major trigger component joining structure are respectively joined with the minor trigger component, so that the first side major trigger component, the second side major trigger component, and the minor trigger component are electrically connected to enable the trigger module to trigger the power supply module, thereby allowing the power supply module to provide the first side terminal power to the first side minor power terminal through the first side major power terminal, and to provide the second side terminal power to the second side minor power terminal through the second side major power terminal.

Preferably, the major connector said above, wherein the time when the trigger module triggers the power supply module is earlier than the time when the power supply module provides the first side terminal power and the second side terminal power.

Preferably, the major connector said above, wherein the time when the minor power terminal set joins the major power terminal set is earlier than the time when the minor trigger component joins the major trigger component set.

Preferably, the major connector said above, wherein the major power terminal set is located between the first side major trigger component and the second side major trigger component.

Preferably, the major connector said above, wherein the major connector is further configured to be equipped with a signal supply module, when the first side major trigger component, the second side major trigger component, and the minor trigger component are electrically connected, the trigger module is further configured to trigger the signal supply module, thereby causing the signal supply module to provide a first side terminal signal and a second side terminal signal, additionally, the minor connector further comprises a minor signal terminal set, the minor signal terminal set comprises a first side minor signal terminal and a second side minor signal terminal, and the major connector further comprises: a major signal terminal set, which is electrically connected to the signal supply module, and the major signal terminal set comprises a first side major signal terminal and a second side major signal terminal, and the first side major signal terminal comprises a first side major signal terminal joining structure, and the second side major signal terminal comprises a second side major signal terminal joining structure, and the first side major signal terminal joining structure is joined with the first side minor signal terminal, and the second side major signal terminal joining structure is joined with the second side minor signal terminal; wherein, the major connector body is further mated with the major signal terminal set to respectively position the first side major signal terminal and the second side major signal terminal, such that the first side major signal terminal joining structure is located at the first major connector body side, and the second side major signal terminal joining structure is located at the second major connector body side; wherein, during the process of the minor connector joining the major connector, the first side major signal terminal joining structure is configured to join the first side minor signal terminal, and the second side major signal terminal joining structure is configured to join the second side minor signal terminal, so that the first side major signal terminal and the first side minor signal terminal are electrically connected, and the second side major signal terminal and the second side minor signal terminal are electrically connected; and when the trigger module triggers the signal supply module, the signal supply module provides the first side terminal signal to the first side minor signal terminal via the first side major signal terminal, and the signal supply module further provides the second side terminal signal to the second side minor signal terminal via the second side major signal terminal.

Preferably, the major connector said above, wherein the time when the trigger module triggers the signal supply module is earlier than the time when the signal supply module provides the first side terminal signal and the second side terminal signal.

Preferably, the major connector said above, wherein the time when the minor signal terminal set joins the major signal terminal set is earlier than the time when the minor trigger component joins the major trigger component set.

Preferably, the major connector said above, wherein the time when the minor power terminal set joins the major power terminal set is earlier than the time when the minor signal terminal set joins the major signal terminal set.

Preferably, the major connector said above, wherein the major signal terminal set is located between the first side major power terminal and the second side major power terminal, and the major signal terminal set is located between the first side major trigger component and the second side major trigger component.

Preferably, the connector assembly said above, which is configured to be equipped with a power supply module and a trigger module, wherein the trigger module is configured to trigger the power supply module to provide a first side terminal power and a second side terminal power, and the connector assembly comprises: a major connector, comprising: a major power terminal set, which is electrically connected to the power supply module, and the major power terminal set comprises a first side major power terminal and a second side major power terminal, and the first side major power terminal comprises a first side major power terminal joining structure, and the second side major power terminal comprises a second side major power terminal joining structure; a major trigger component set, which is electrically connected to the trigger module, and the major trigger component set comprises a first side major trigger component and a second side major trigger component, and the first side major trigger component comprises a first side major trigger component joining structure, and the second side major trigger component comprises a second side major trigger component joining structure; and a major connector body, which comprises a major connector body joining guiding structure, and the two sides of the major connector body are respectively a first major connector body side and a second major connector body side, and the major connector body is respectively mated with the major power terminal set and the major trigger component set to respectively position the first side major power terminal, the second side major power terminal, the first side major trigger component, and the second side major trigger component, such that the first side major power terminal joining structure is located at the first major connector body side, and the second side major power terminal joining structure is located at the second major connector body side, furthermore, the first side major trigger component joining structure is located at the first major connector body side, and the second side major trigger component joining structure is located at the second major connector body side; and a minor connector, which is configured to join the major connector, the minor connector comprises: a minor power terminal set, which comprises a first side minor power terminal and a second side minor power terminal, and the first side minor power terminal comprises a first side minor power terminal joining structure, and the second side minor power terminal comprises a second side minor power terminal joining structure, and the first side minor power terminal joining structure is configured to join the first side major power terminal joining structure, and the second side minor power terminal joining structure is configured to join the second side major power terminal joining structure; and a minor trigger component, which comprises a first side minor trigger component joining structure and a second side minor trigger component joining structure, and the first side minor trigger component joining structure is configured to join the first side major trigger component joining structure and the second side minor trigger component joining structure is configured to join the second side major trigger component joining structure; wherein, during the process of the minor connector joining the major connector, the major connector body joining guiding structure is configured to guide the minor power terminal set to join the major power terminal set, and guide the minor trigger component to join the major trigger component set, allowing the first side minor power terminal joining structure to join the first side major power terminal joining structure, and allowing the second side minor power terminal joining structure to join the second side major power terminal joining structure, so that the first side major power terminal and the first side minor power terminal are electrically connected, and the second side major power terminal and the second side minor power terminal are electrically connected, additionally, the first side minor trigger component joining structure join the first side major trigger component joining structure, and the second side minor trigger component joining structure join the second side major trigger component joining structure, so that the first side major trigger component, the second side major trigger component, and the minor trigger component are electrically connected to enable the trigger module to trigger the power supply module, thereby causing the power supply module to provide the first side terminal power to the first side minor power terminal via the first side major power terminal, and to provide the second side terminal power to the second side minor power terminal via the second side major power terminal.

Preferably, the connector assembly said above, wherein the minor trigger component is a conductive shell, and the first side major trigger component and the second side major trigger component are respectively configured as elastic conductive terminals that abut against the minor trigger component.

Preferably, the connector assembly said above, wherein the minor trigger component further comprises a minor trigger component joining retaining structure, wherein the minor trigger component joining retaining structure is configured to contact the major connector body, thereby retaining the minor connector joined with the major connector.

Preferably, the connector assembly said above, wherein the first side major trigger component joining structure and the second side major trigger component joining structure are respectively configured as elastic arm joining structures.

Preferably, the connector assembly said above, wherein the first side minor trigger component joining structure and the second side minor trigger component joining structure are respectively configured as wall joining structures.

Preferably, the connector assembly said above, wherein the first side minor power terminal and the second side minor power terminal are respectively configured as blade-type conductive terminals, and the first side major power terminal and the second side major power terminal are respectively configured as clamping-type terminals.

Preferably, the connector assembly said above, wherein the minor power terminal set is located between the first side minor trigger component joining structure and the second side minor trigger component joining structure.

Preferably, the connector assembly said above, wherein, the connector assembly is further configured to be equipped with a signal supply module, wherein the trigger module is further configured to trigger the signal supply module, causing the signal supply module to provide a first side terminal signal and a second side terminal signal; the major connector further comprises: a major signal terminal set, which is electrically connected to the signal supply module, and the major signal terminal set comprises a first side major signal terminal and a second side major signal terminal, the first side major signal terminal a first side major signal terminal joining structure, and the second side major signal terminal comprises a second side major signal terminal joining structure; wherein the major connector body is further mated with the major signal terminal set to respectively position the first side major signal terminal and the second side major signal terminal, so that the first side major signal terminal joining structure is located at the first major connector body side, and the second side major signal terminal joining structure is located at the second major connector body side; and the minor connector further comprises: a minor signal terminal set, which comprises a first side minor signal terminal and a second side minor signal terminal, the first side minor signal terminal comprises a first side minor signal terminal joining structure, and the second side minor signal terminal comprises a second side minor signal terminal joining structure, the first side minor signal terminal joining structure is configured to join the first side major signal terminal joining structure, and the second side minor signal terminal joining structure is configured to join the second side major signal terminal joining structure; wherein, during the process of the minor connector joining the major connector, the major connector body joining guiding structure is further configured to guide the minor signal terminal set to join the major signal terminal set, so that the first side minor signal terminal joining structure joins the first side major signal terminal joining structure, and the second side minor signal terminal joining structure joins the second side major signal terminal joining structure, allowing the first side major signal terminal and the first side minor signal terminal to be electrically connected, and allowing the second side major signal terminal and the second side minor signal terminal to be electrically connected; and when the first side major trigger component, the second side major trigger component, and the minor trigger component are electrically connected, the trigger module further triggers the signal supply module, thereby causing the signal supply module to provide the first side terminal signal to the first side minor signal terminal via the first side major signal terminal, and to provide the second side terminal signal to the second side minor signal terminal via the second side major signal terminal.

Preferably, the connector assembly said above, wherein the first side minor signal terminal and the second side minor signal terminal are respectively configured as blade-type conductive terminals, and the first side major signal terminal and the second side major signal terminal are respectively configured as clamping-type terminals.

Preferably, the connector assembly said above, wherein the minor signal terminal set is located between the first side minor power terminal and the second side minor power terminal, and the minor signal terminal set is located between the first side minor trigger component joining structure and the second side minor trigger component joining structure.

Preferably, the connector assembly said above, wherein the minor trigger component further comprises a minor trigger component joining guiding structure, wherein during the process of the minor connector joining the major connector, the minor trigger component joining guiding structure is configured to cooperate with the major connector body joining guiding structure to guide the minor power terminal set to join the major power terminal set, the minor trigger component to join the major trigger component set, and the minor signal terminal set to join the major signal terminal set.

Compared to prior art, the present application provides a connector assembly and a major connector thereof. The connector assembly further comprises a minor connector that can be joined with the major connector, and the connector assembly is configured with a trigger component. The trigger component is configured to trigger the transmission of power or signals only when the major connector and the minor connector are properly joined. In this way, it solves the technical problem where multiple connectors belonging to a conventional connector assembly fail to transmit power or signals effectively due to improper joining, thereby enabling the connector assembly of the present application to timely transmit power or signals and function as expected in electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of the connector assembly according to an embodiment of the present application.

FIG. 2 is a perspective schematic view of the connector assembly from a first viewpoint according to an embodiment of the present application.

FIG. 3 is a perspective schematic view of the connector assembly from a second viewpoint according to an embodiment of the present application.

FIG. 4 is a top view schematic of the connector assembly according to an embodiment of the present application.

FIG. 5 is a cross-sectional schematic view of a part of the connector assembly shown in FIG. 4, taken along line AA.

FIG. 6 is a cross-sectional schematic view of a part of the connector assembly shown in FIG. 4, taken along line A′A′.

FIG. 7 is a front view schematic of the connector assembly according to an embodiment of the present application.

FIG. 8 is a perspective schematic view of the connector assembly according to an embodiment of the present application.

FIG. 9 is a perspective schematic view of the connector assembly from a first viewpoint according to an embodiment of the present application.

FIG. 10 is a front view schematic of the connector assembly according to an embodiment of the present application.

FIG. 11 is a perspective schematic view of the connector assembly according to an embodiment of the present application.

FIG. 12 is a front view schematic of the connector assembly according to an embodiment of the present application.

FIG. 13 is a perspective schematic view of the connector assembly according to an embodiment of the present application.

FIG. 14 is a perspective schematic view of the minor connector according to an embodiment of the present application.

FIG. 15 is a perspective schematic view of the major connector according to an embodiment of the present application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Additionally, it should be noted that, in order to make the disclosed content more concise and easy to understand, elements with the same or similar functions in the following embodiments will be described using the same symbols, and descriptions of identical or equivalent features will be omitted.

The present application provides a connector assembly, which comprises a major connector and a minor connector that can be joined, and the connector assembly transmits power or signals only when the major connector and the minor connector are properly joined in place. In this way, the technical issue of conventional connector assemblies, where multiple connectors belonging to the connector assembly fail to effectively transmit power or signals due to improper joining, can be resolved, thereby enabling the connector assembly of the present application to perform as expected in electronic devices.

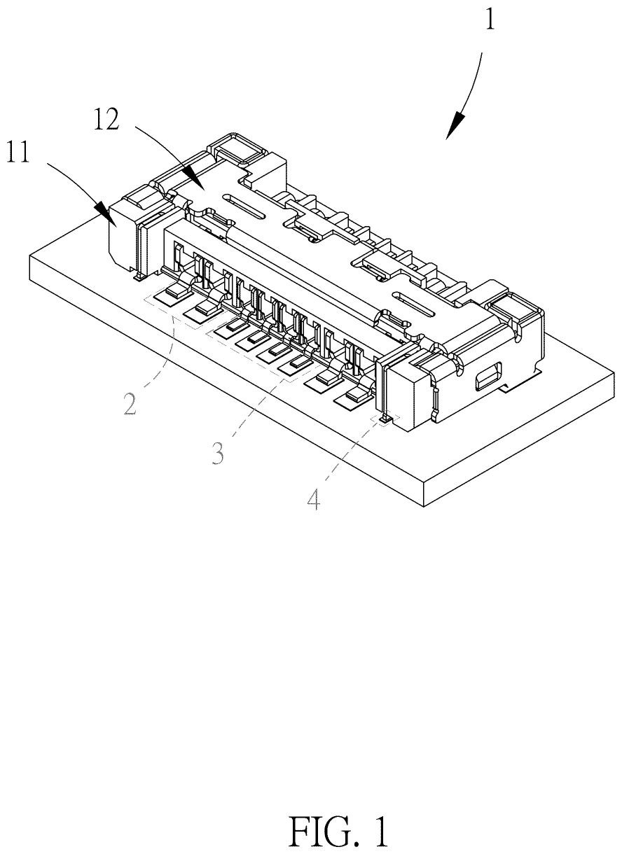

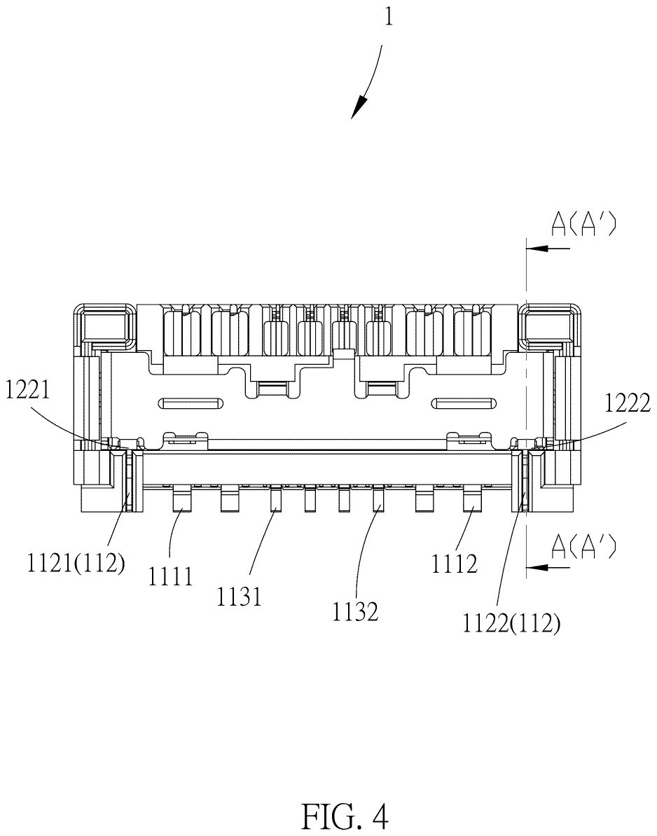

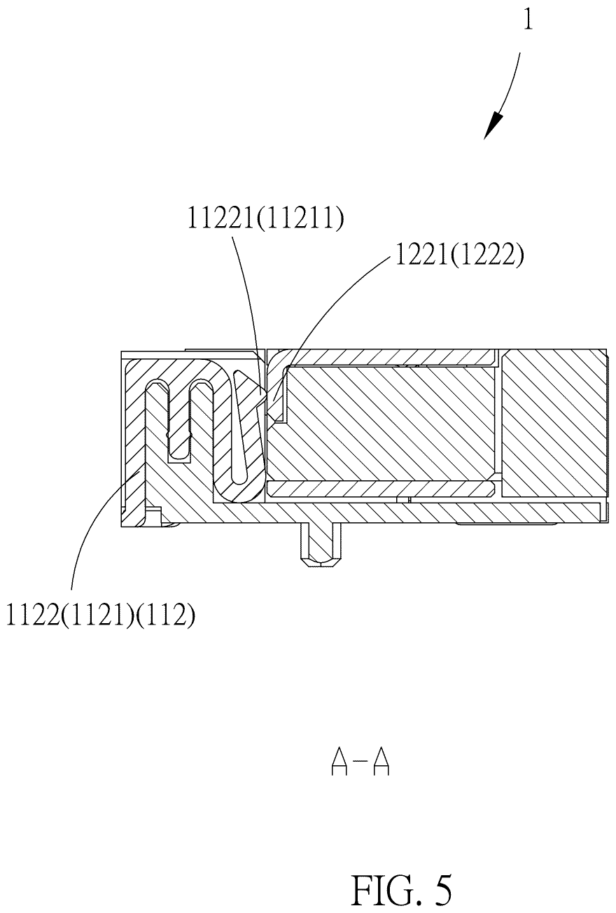

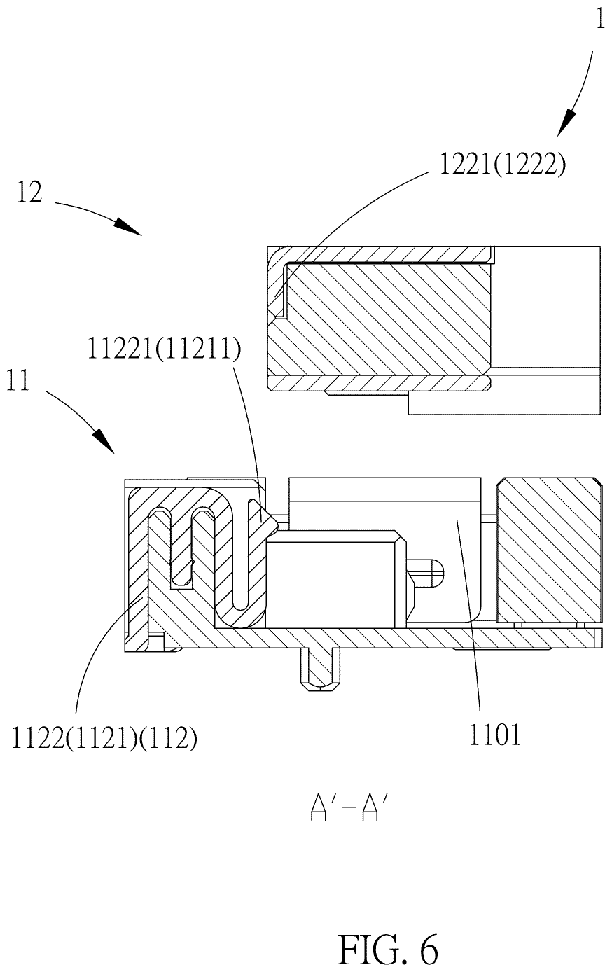

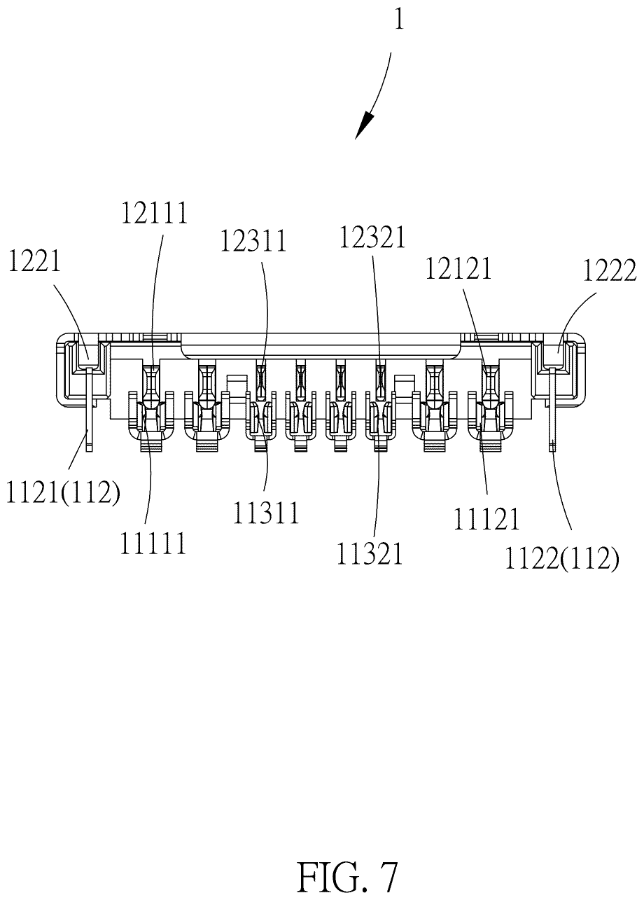

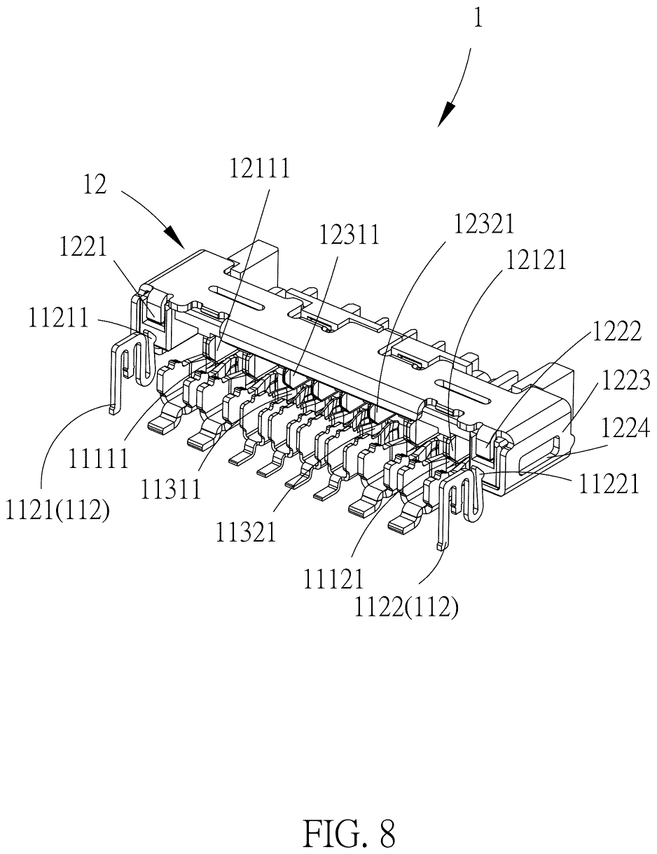

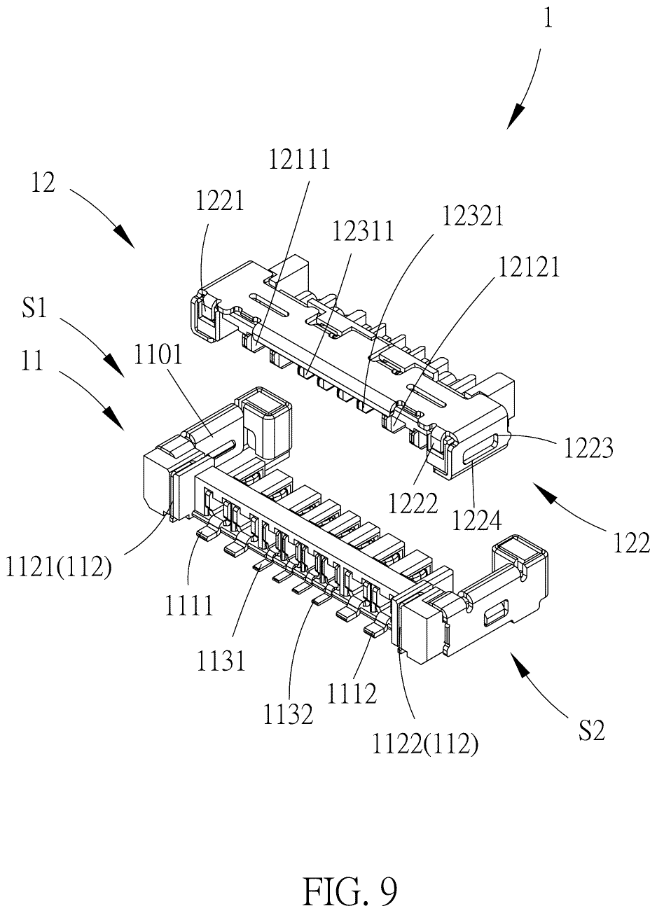

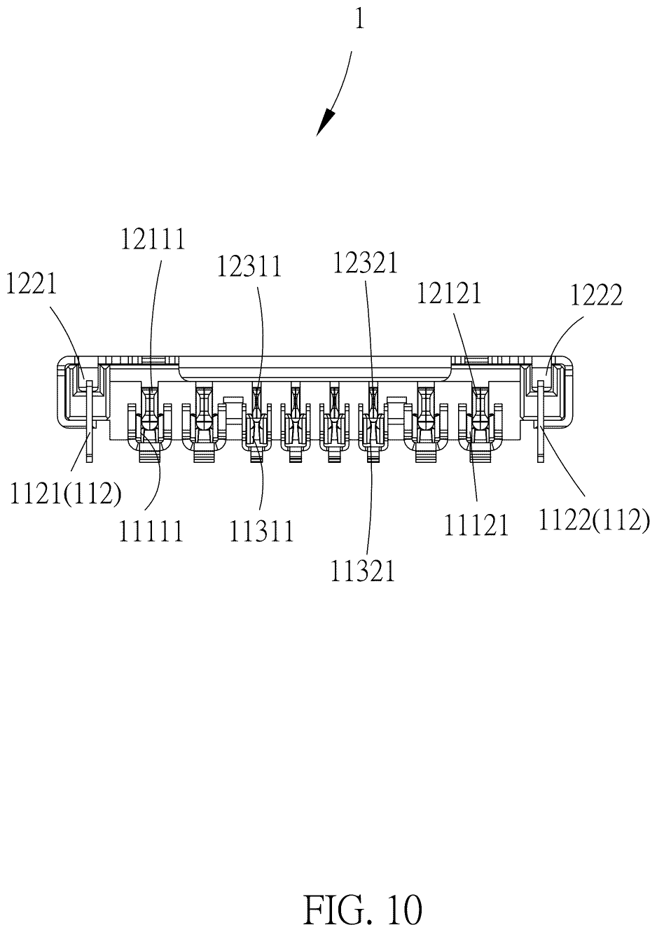

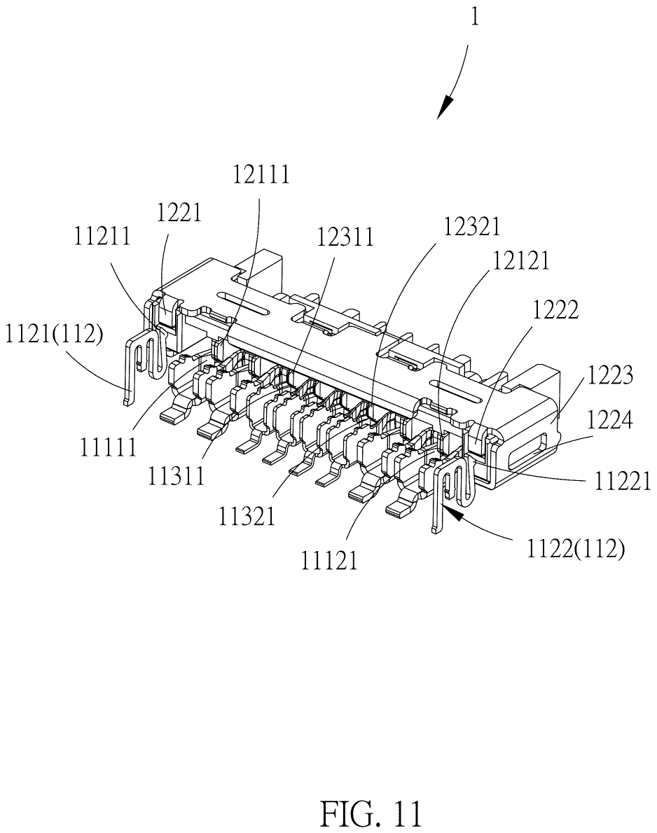

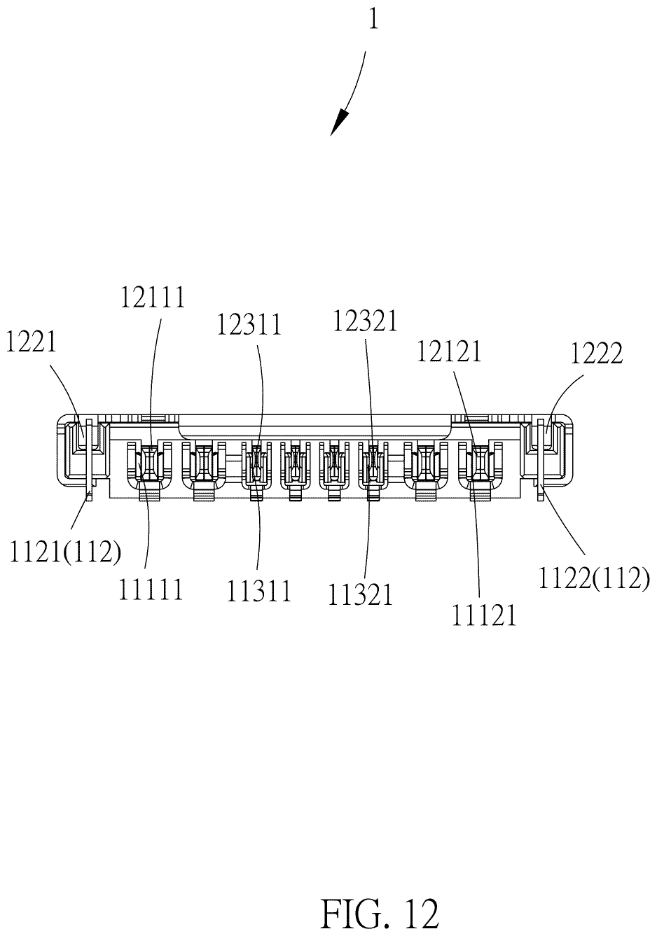

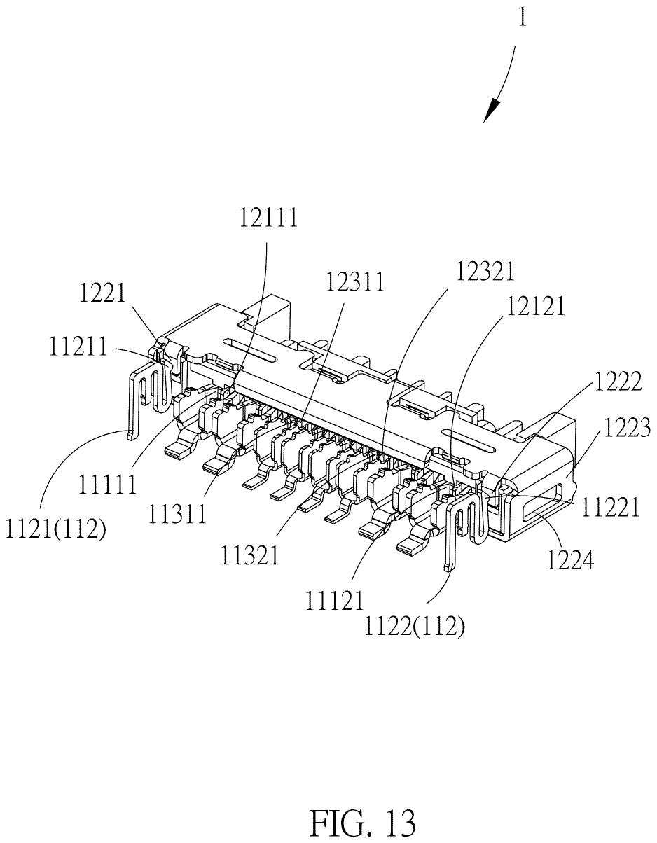

For a detailed description of the embodiments disclosed in the present application, please refer to FIGS. 1 to 15.

In the embodiments shown in FIGS. 1 to 15, a connector assembly 1 is provided, which is configured to be equipped with a power supply module 2, a signal supply module 3, and a trigger module 4. The trigger module 4 is configured to receive a trigger command to trigger the power supply module 2 or the signal supply module 3, causing the power supply module 2 to provide a first side terminal power and a second side terminal power, or causing the signal supply module 3 to provide a first side terminal signal and a second side terminal signal.

As shown in FIGS. 1 to 13, the connector assembly 1 comprises: a major connector 11 and a minor connector 12. The minor connector 12 can be joined with the major connector 11. Optionally, the power supply module 2, the signal supply module 3, and the trigger module 4 are arranged on a circuit substrate, and the major connector 11 serves as a board-end connector disposed on the circuit substrate. Correspondingly, the minor connector 12 serves as a wire-end connector that can be joined with the major connector 11.

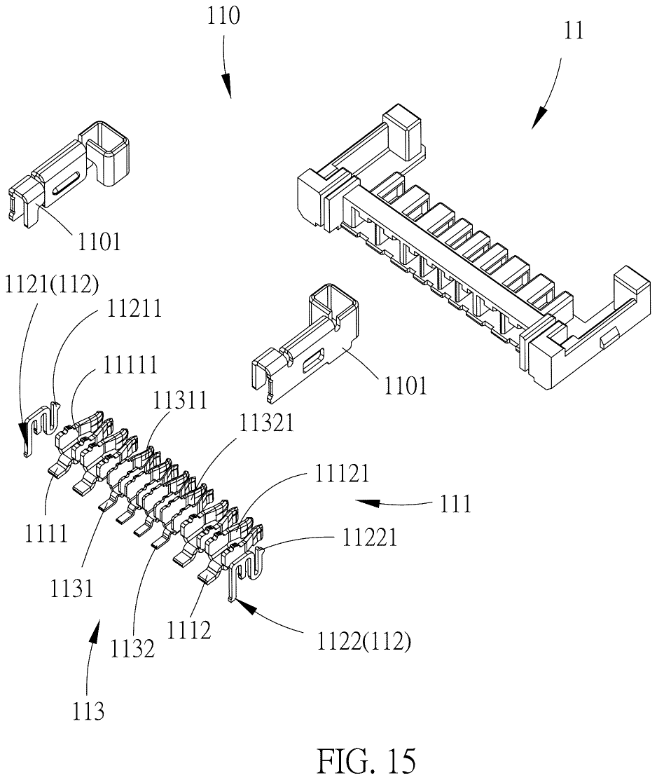

Regarding the major connector 11, as shown in FIG. 15, the major connector 11 comprises: a major power terminal set 111, a major trigger component set 112, a major signal terminal set 113, and a major connector body 110.

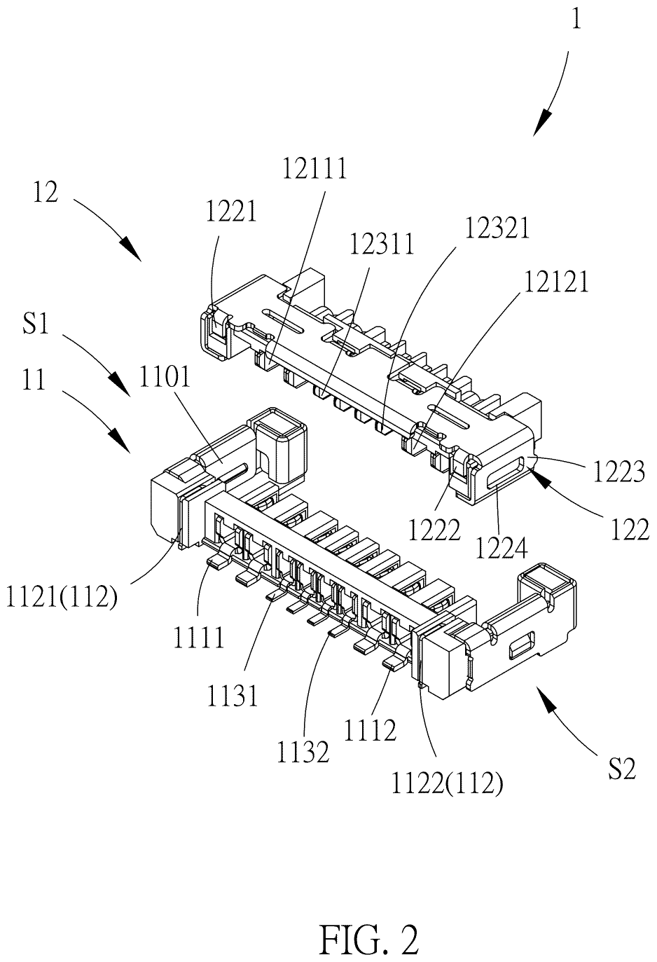

Regarding the major power terminal set 111, as shown in FIGS. 2, 4, 7 to 13, and 15, the major power terminal set 111 comprises a first side major power terminal 1111 and a second side major power terminal 1112. The first side major power terminal 1111 comprises a first side major power terminal joining structure 11111, and the second side major power terminal 1112 comprises a second side major power terminal joining structure 11121. In the above embodiments, the major power terminal set 111 (comprising the first side major power terminal 1111 and the second side major power terminal 1112) is electrically connected to the power supply module 2, thereby allowing the power supply module 2 to provide the first side terminal power through the first side major power terminal 1111 (i.e., the major power terminal set 111), and to provide the second side terminal power through the second side major power terminal 1112 (i.e., the major power terminal set 111).

Regarding the major trigger component set 112, as shown in FIGS. 2 to 14, the major trigger component set 112 comprises a first side major trigger component 1121 and a second side major trigger component 1122. The first side major trigger component 1121 comprises a first side major trigger component joining structure 11211, and the second side major trigger component 1122 comprises a second side major trigger component joining structure 11221. In the above embodiments, the major trigger component set 112 is electrically connected to the trigger module 4 (comprising the first side major trigger component 1121 and the second side major trigger component 1122), thereby allowing the trigger module 4 (comprising the first side major trigger component 1121 and the second side major trigger component 1122) to receive the trigger command via the major trigger component set 112.

Regarding the major signal terminal set 113, as shown in FIGS. 2, 4, 7 to 13, and 15, the major signal terminal set 113 comprises a first side major signal terminal 1131 and a second side major signal terminal 1132. The first side major signal terminal 1131 comprises a first side major signal terminal joining structure 11311, and the second side major signal terminal 1132 comprises a second side major signal terminal joining structure 11321. In the above embodiments, the major signal terminal set 113 (comprising the first side major signal terminal 1131 and the second side major signal terminal 1132) is electrically connected to the signal supply module 3, thereby allowing the signal supply module 3 to provide the first side terminal signal through the first side major signal terminal 1131 (i.e., the major signal terminal set 113), and to provide the second side terminal signal through the second side major signal terminal 1132 (i.e., the major signal terminal set 113).

Regarding the major connector body 110, as shown in FIGS. 2 to 3, 6, 9, and 15, the major connector body 110 comprises a major connector body joining guiding structure 1101, which is configured to guide the minor connector 12 to join the major connector 11. The two sides of the major connector body 110 are respectively a first major connector body side S1 and a second major connector body side S2. The major connector body 110 is respectively mated with the major power terminal set 111, the major trigger component set 112, and the major signal terminal set 113 to respectively position the first side major power terminal 1111, the second side major power terminal 1112, the first side major trigger component 1121, the second side major trigger component 1122, the first side major signal terminal 1131, and the second side major signal terminal 1132, so that the first side major power terminal joining structure 11111, the first side major trigger component joining structure 11211, and the first side major signal terminal joining structure 11311 are respectively located at the first major connector body side S1, and the second side major power terminal joining structure 11121, the second side major trigger component joining structure 11221, and the second side major signal terminal joining structure 11321 are respectively located at the second major connector body side S2.

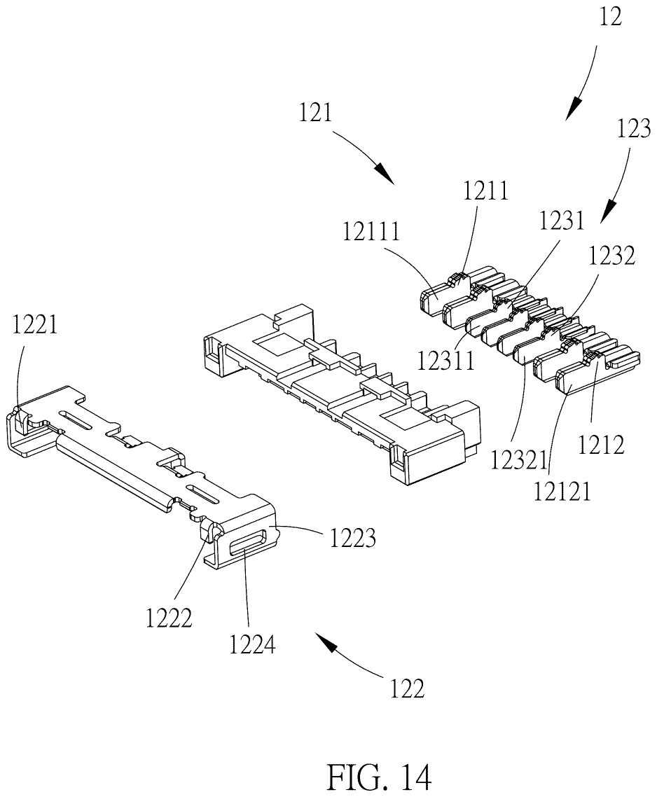

Regarding the minor connector 12, as shown in FIG. 14, the minor connector 12 comprises: a minor power terminal set 121, a minor trigger component 122, and a minor signal terminal set 123.

Regarding the minor power terminal set 121, as shown in FIGS. 2 and 7 to 14, the minor power terminal set 121 comprises a first side minor power terminal 1211 and a second side minor power terminal 1212. The first side minor power terminal 1211 comprises a first side minor power terminal joining structure 12111, and the second side minor power terminal 1212 comprises a second side minor power terminal joining structure 12121. The first side minor power terminal joining structure 12111 is configured to join the first side major power terminal joining structure 11111, and the second side minor power terminal joining structure 12121 is configured to join the second side major power terminal joining structure 11121, that is, the first side major power terminal joining structure 11111 is configured to join the first side minor power terminal 1211, and the second side major power terminal joining structure 11121 is configured to join the second side minor power terminal 1212.

Regarding the minor trigger component 122, as shown in FIGS. 2, 4 to 14, the minor trigger component 122 comprises a first side minor trigger component joining structure 1221, a second side minor trigger component joining structure 1222, and a minor trigger component joining guiding structure 1223. The first side minor trigger component joining structure 1221 is configured to join the first side major trigger component joining structure 11211, and the second side minor trigger component joining structure 1222 is configured to join the second side major trigger component joining structure 11221, that is, the first side major trigger component joining structure 11211 and the second side major trigger component joining structure 11221 are respectively configured to join the minor trigger component 122.

Regarding the minor signal terminal set 123, as shown in FIGS. 2 and 7 to 14, the minor signal terminal set 123 comprises a first side minor signal terminal 1231 and a second side minor signal terminal 1232. The first side minor signal terminal 1231 comprises a first side minor signal terminal joining structure 12311, and the second side minor signal terminal 1232 comprises a second side minor signal terminal joining structure 12321. The first side minor signal terminal joining structure 12311 is configured to join the first side major signal terminal joining structure 11311, and the second side minor signal terminal joining structure 12321 is configured to join the second side major signal terminal joining structure 11321, that is, the first side major signal terminal joining structure 11311 is configured to join the first side minor signal terminal 1231, and the second side major signal terminal joining structure 11321 is configured to join the second side minor signal terminal 1232.

It should be noted that, during the process of the minor connector 12 joining the major connector 11, the minor trigger component joining guiding structure 1223 is configured to cooperate with the major connector body joining guiding structure 1101 to guide the minor power terminal set 121 to join the major power terminal set 111, and guide the minor trigger component 122 to join the major trigger component set 112, so that the first side minor power terminal joining structure 12111 (i.e., the first side minor power terminal 1211) joins the first side major power terminal joining structure 11111, and the second side minor power terminal joining structure 12121 (i.e., the second side minor power terminal 1212) joins second side major power terminal joining structure 11121, making the first side major power terminal 1111 and the first side minor power terminal 1211 electrically connected, and the second side major power terminal 1112 and the second side minor power terminal 1212 electrically connected, and allowing the first side minor trigger component joining structure 1221 and the second side minor trigger component joining structure 1222 to respectively join the minor trigger component 122 (comprising the first side major trigger component joining structure 11211 and the second side major trigger component joining structure 11221), so that the first side major trigger component 1121, the second side major trigger component 1122, and the minor trigger component 122 are electrically connected, allowing the trigger module 4 to trigger the power supply module 2, thereby enabling the power supply module 2 to provide the first side terminal power through the first side major power terminal 1111 to the first side minor power terminal 1211, and to provide the second side terminal power through the second side major power terminal 1112 to the second side minor power terminal 1212.

It should be noted that, in the above embodiments, the time when the major power terminal set 111 joins the minor power terminal set 121 is earlier than the time when the major trigger component set 112 joins the minor trigger component 122, and the time when the trigger module 4 triggers the power supply module 2 is earlier than the time when the power supply module 2 provides the first side terminal power and the second side terminal power. In this way, it means that the trigger module 4 triggers the power supply module 2 to provide the first side terminal power and the second side terminal power only after the major power terminal set 111 and the minor power terminal set 121 are properly joined, thereby ensuring stable power transmission through the connector assembly 1 in various electronic devices, solving the problem of conventional connector assemblies failing to transmit power effectively due to improper joining.

Additionally, during the process of the minor connector 12 joining the major connector 11, the minor trigger component joining guiding structure 1223 is configured to cooperate with the major connector body joining guiding structure 1101 to guide the minor signal terminal set 123 to join the major signal terminal set 113, making the first side minor signal terminal joining structure 12311 joins the first side major signal terminal joining structure 11311, and the second side minor signal terminal joining structure 12321 joins the second side major signal terminal joining structure 11321, enabling electrical connection between the first side major signal terminal 1131 and the first side minor signal terminal 1231, and between the second side major signal terminal 1132 and the second side minor signal terminal 1232.

Furthermore, when the first side major trigger component 1121, the second side major trigger component 1122, and the minor trigger component 122 are electrically connected, the trigger module 4 is further configured to trigger the signal supply module 3, thereby allowing the signal supply module 3 to provide the first side terminal signal to the first side minor signal terminal 1231 via the first side major signal terminal 1131, and the signal supply module 3 further provides the second side terminal signal to the second side minor signal terminal 1232 via the second side major signal terminal 1132.

It should be noted that, in the above embodiments, the time when the minor signal terminal set 123 joins the major signal terminal set 113 is earlier than the time when the minor trigger component 122 joins the major trigger component set 112, and the time when the trigger module 4 triggers the signal supply module 3 is earlier than the time when the signal supply module 3 provides the first side terminal signal and the second side terminal signal. In this way, it means that the trigger module 4 triggers the signal supply module 3 to provide the first side terminal signal and the second side terminal signal only after the minor signal terminal set 123 and the major signal terminal set 113 are properly joined, thereby allowing the connector assembly 1 to stably transmit the first side terminal signal and the second side terminal signal, ensuring that the signal transmission of the connector assembly 1 in various electronic devices meets expectations. In this way, the technical problem of conventional connector assemblies failing to effectively transmit signals due to improper joining can be resolved.

Additionally, it should be noted that, in the above embodiments, the time when the minor power terminal set 121 joins the major power terminal set 111 is earlier than the time when the minor signal terminal set 123 joins the major signal terminal set 113. In this way, it means that the minor signal terminal set 123 joins the major signal terminal set 113 only after the minor power terminal set 121 and the major power terminal set 111 are properly joined. In this way, the technical problem of the minor signal terminal set 123 joining the major signal terminal set 113 before the minor power terminal set 121 and the major power terminal set 111 are properly joined can be avoided.

In the embodiments shown in FIGS. 2 to 3 and 7 to 13, in order to maintain the joining state between the major power terminal set 111 and the minor power terminal set 121, the first side minor power terminal 1211 and the second side minor power terminal 1212 are respectively configured as blade-type conductive terminals. Correspondingly, the first side major power terminal 1111 and the second side major power terminal 1112 are respectively configured as clamping-type terminals. Additionally, in order to maintain the joining state between the major signal terminal set 113 and the minor signal terminal set 123, the first side minor signal terminal 1231 and the second side minor signal terminal 1232 are respectively configured as blade-type conductive terminals. Correspondingly, the first side major signal terminal 1131 and the second side major signal terminal 1132 are respectively configured as clamping-type terminals.

In the embodiments shown in FIGS. 2 to 3 and 7 to 13, the major power terminal set 111 is located between the first side major trigger component 1121 and the second side major trigger component 1122. Correspondingly, the minor power terminal set 121 is located between the first side minor trigger component joining structure 1221 and the second side minor trigger component joining structure 1222, to ensure that the minor trigger component 122 joins the major trigger component set 112 only after the minor power terminal set 121 and the major power terminal set 111 are properly joined.

Additionally, the major signal terminal set 113 is located between the first side major power terminal 1111 and the second side major power terminal 1112. Correspondingly, the minor signal terminal set 123 is located between the first side minor power terminal 1211 and the second side minor power terminal 1212, to ensure that the minor signal terminal set 123 joins the major signal terminal set 113 only after the minor power terminal set 121 and the major power terminal set 111 are properly joined.

Furthermore, the major signal terminal set 113 is located between the first side major trigger component 1121 and the second side major trigger component 1122. Correspondingly, the minor signal terminal set 123 is located between the first side minor trigger component joining structure 1221 and the second side minor trigger component joining structure 1222, to ensure that the minor trigger component 122 joins the major trigger component set 112 only after the minor signal terminal set 123 and the major signal terminal set 113 are properly joined.

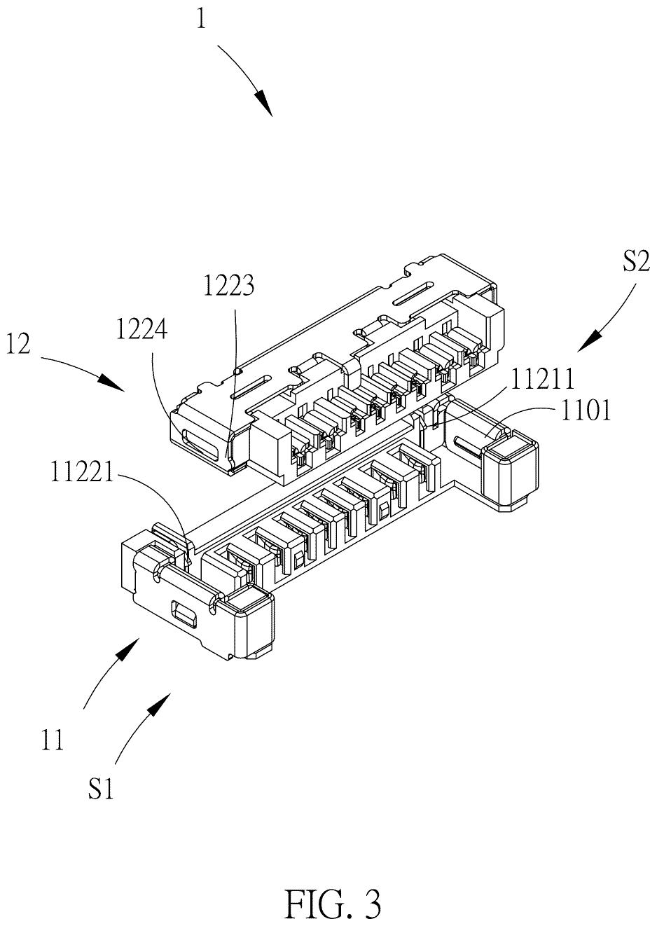

The minor trigger component 122 may optionally be a conductive shell of the minor connector 12. Correspondingly, the first side major trigger component 1121 and the second side major trigger component 1122 may optionally be elastic conductive terminals that elastically abut the minor trigger component 122. In the embodiments shown in FIGS. 3, 5, 6, 8, 11, 13, and 15, the first side major trigger component joining structure 11211 and the second side major trigger component joining structure 11221 are respectively configured as elastic arm joining structures. In this way, the first side major trigger component 1121 and the second side major trigger component 1122 can respectively elastically abut the minor trigger component 122, so that the joining of the major trigger component set 112 to the minor trigger component 122 meets expectations. Correspondingly, the first side minor trigger component joining structure 1221 and the second side minor trigger component joining structure 1222 are respectively configured as wall joining structures. In this way, the first side minor trigger component joining structure 1221 can limit the degree of elastic deformation of the first side major trigger component joining structure 11211, and the second side minor trigger component joining structure 1222 can limit the degree of elastic deformation of the second side major trigger component joining structure 11221, to prevent excessive elastic deformation that may cause damage.

In the embodiments shown in FIGS. 2 to 3, 8 to 9, 11, and 13 to 14, the minor trigger component 122 further comprises a minor trigger component joining retaining structure 1224, wherein the minor trigger component joining retaining structure 1224 is a groove structure that can contact the major connector body 110, thereby maintaining the joined state between the minor connector 12 and the major connector 11.

It should be noted that the connector assembly and its major connector of the present application may omit some components and are not limited to the above-described embodiments.

For example, the connector assembly of the present application may optionally comprise only: a major connector and a minor connector. The major connector comprises: a major power terminal set, a major trigger component set, and a major connector body. The major power terminal set is electrically connected to the power supply module, and the major power terminal set comprises a first side major power terminal and a second side major power terminal. The first side major power terminal comprises a first side major power terminal joining structure, and the second side major power terminal comprises a second side major power terminal joining structure. The major trigger component set is electrically connected to the trigger module, and the major trigger component set comprises a first side major trigger component and a second side major trigger component. The first side major trigger component comprises a first side major trigger component joining structure, and the second side major trigger component comprises a second side major trigger component joining structure. The major connector body comprises a major connector body joining guiding structure, and the two sides of the major connector body are respectively a first major connector body side and a second major connector body side. The major connector body is respectively mated with the major power terminal set and the major trigger component set to respectively position the first side major power terminal, the second side major power terminal, the first side major trigger component, and the second side major trigger component, so that the first side major power terminal joining structure is located at the first major connector body side, and the second side major power terminal joining structure is located at the second major connector body side, and the first side major trigger component joining structure is located at the first major connector body side, and the second side major trigger component joining structure is located at the second major connector body side. The minor connector is configured to join the major connector, and the minor connector comprises: a minor power terminal set and a minor trigger component. The minor power terminal set comprises a first side minor power terminal and a second side minor power terminal. The first side minor power terminal comprises a first side minor power terminal joining structure, and the second side minor power terminal comprises a second side minor power terminal joining structure. The first side minor power terminal joining structure is configured to join the first side major power terminal joining structure, and the second side minor power terminal joining structure is configured to join the second side major power terminal joining structure. The minor trigger component comprises a first side minor trigger component joining structure and a second side minor trigger component joining structure. The first side minor trigger component joining structure is configured to join the first side major trigger component joining structure, and the second side minor trigger component joining structure is configured to join the second side major trigger component joining structure; wherein during the process of the minor connector joining the major connector, the major connector body joining guiding structure is configured to guide the minor power terminal set join the major power terminal set, and guide the minor trigger component to join the major trigger component set, allowing the first side minor power terminal joining structure to join the first side major power terminal joining structure, and the second side minor power terminal joining structure to join the second side major power terminal joining structure, allowing the first side major power terminal and the first side minor power terminal to be electrically connected, and allowing the second side major power terminal and the second side minor power terminal to be electrically connected, also allowing the first side minor trigger component joining structure and the second side minor trigger component joining structure to respectively join the first side major trigger component joining structure and the second side major trigger component joining structure, allowing the first side major trigger component, the second side major trigger component, and the minor trigger component to be electrically connected so that the trigger module triggers the power supply module, thereby allowing the power supply module to provide the first side terminal power through the first side major power terminal to the first side minor power terminal, and to provide the second side terminal power through the second side major power terminal to the second side minor power terminal.

Additionally, the major connector of the present application may optionally comprise only: a major power terminal set, a major trigger component set, and a major connector body. The major power terminal set is electrically connected to the power supply module, and the major power terminal set comprises a first side major power terminal and a second side major power terminal. The first side major power terminal comprises a first side major power terminal joining structure, and the second side major power terminal comprises a second side major power terminal joining structure. The first side major power terminal joining structure is configured to join the first side minor power terminal, and the second side major power terminal joining structure is configured to join the second side minor power terminal. The major trigger component set is electrically connected to the trigger module, and the major trigger component set comprises a first side major trigger component and a second side major trigger component. The first side major trigger component comprises a first side major trigger component joining structure, and the second side major trigger component comprises a second side major trigger component joining structure. The first side major trigger component joining structure and the second side major trigger component joining structure are respectively configured to join the minor trigger component. The two sides of the major connector body are respectively the first major connector body side and the second major connector body side. The major connector body is respectively mated with the major power terminal set and the major trigger component set to respectively position the first side major power terminal, the second side major power terminal, the first side major trigger component, and the second side major trigger component, so that the first side major power terminal joining structure is located at the first major connector body side, and the second side major power terminal joining structure is located at the second major connector body side, and the first side major trigger component joining structure is located at the first major connector body side, and the second side major trigger component joining structure is located at the second major connector body side; wherein, the minor connector is configured to join the major connector, allowing the first side minor power terminal to join the first side major power terminal joining structure, and the second side minor power terminal to join the second side major power terminal joining structure, allowing the first side major power terminal and the first side minor power terminal to be electrically connected, and allowing the second side major power terminal and the second side minor power terminal to be electrically connected, also allowing the first side major trigger component joining structure and the second side major trigger component joining structure to respectively join the minor trigger component, allowing the first side major trigger component, the second side major trigger component, and the minor trigger component to be electrically connected so that the trigger module triggers the power supply module, thereby allowing the power supply module to provide the first side terminal power through the first side major power terminal to the first side minor power terminal, and to provide the second side terminal power through the second side major power terminal to the second side minor power terminal.

In summary, the present application provides a connector assembly and a major connector thereof. The connector assembly further comprises a minor connector that can be joined with the major connector, and the connector assembly is provided with a trigger component that can trigger power or signal transmission only when the major connector and the minor connector are properly joined. In this way, it solves the technical problem where multiple connectors belonging to a conventional connector assembly fail to transmit power or signals effectively due to improper joining, thereby enabling the connector assembly of the present application to timely transmit power or signals and function as expected in electronic devices.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A major connector for being used with a power supply module and a trigger module, wherein the trigger module is configured to trigger the power supply module to provide a first side terminal power and a second side terminal power, and the major connector is configured to be used with a minor connector, wherein the minor connector comprises a minor power terminal set and a minor trigger component, and the minor power terminal set comprises a first side minor power terminal and a second side minor power terminal, and the major connector comprises:
a major power terminal set electrically connected to the power supply module, the major power terminal set comprising a first side major power terminal and a second side major power terminal, wherein the first side major power terminal comprises a first side major power terminal joining structure, and the second side major power terminal comprises a second side major power terminal joining structure, wherein the first side major power terminal joining structure is joined with the first side minor power terminal, and the second side major power terminal joining structure is joined with the second side minor power terminal;
a major trigger component set electrically connected to the trigger module, the major trigger component set comprising a first side major trigger component and a second side major trigger component, wherein the first side major trigger component comprises a first side major trigger component joining structure, and the second side major trigger component comprises a second side major trigger component joining structure, wherein the first side major trigger component joining structure and the second side major trigger component joining structure are respectively joined with the minor trigger component; and
a major connector body comprising a first major connector body side and a second major connector body side respectively formed on two sides thereof, wherein the major connector body is mated with the major power terminal set and the major trigger component set to respectively set the first side major power terminal, the second side major power terminal, the first side major trigger component and the second side major trigger component in position, such that the first side major power terminal joining structure is located at the first major connector body side, the second side major power terminal joining structure is located at the second major connector body side, the first side major trigger component joining structure is located at the first major connector body side, and the second side major trigger component joining structure is located at and the second major connector body side; wherein,
the minor connector is configured for being joined with the major connector, wherein the first side minor power terminal is joined with the first side major power terminal joining structure, and the second side minor power terminal is joined with the second side major power terminal joining structure, so as to allow the first side major power terminal and the first side minor power terminal to be electrically connected to each other, and allow the second side major power terminal and the second side minor power terminal to be electrically connected to each other, and wherein the first side major trigger component joining structure and the second side major trigger component joining structure are respectively joined with the minor trigger component, and the first side major trigger component, the second side major trigger component and the minor trigger component are electrically connected to each other to allow the power supply module to be triggered by the trigger module to provide the first side terminal power to the first side minor power terminal through the first side major power terminal and to provide the second side terminal power to the second side minor power terminal through the second side major power terminal.

2. The major connector of claim 1, wherein the time when the trigger module triggers the power supply module is earlier than the time when the power supply module provides the first side terminal power and the second side terminal power.

3. The major connector of claim 1, wherein the time when the minor power terminal set is joined with the major power terminal set is earlier than the time when the minor trigger component is joined with the major trigger component set.

4. The major connector of claim 1, wherein the major power terminal set is located between the first side major trigger component and the second side major trigger component.

5. The major connector of claim 1, wherein the major connector is further configured to be used with a signal supply module, and with the first side major trigger component, the second side major trigger component and the minor trigger component being electrically connected to each other, the trigger module is further configured to trigger the signal supply module to provide a first side terminal signal and a second side terminal signal, and wherein the minor connector further comprises a minor signal terminal set, which comprises a first side minor signal terminal and a second side minor signal terminal, and the major connector further comprises:
a major signal terminal set electrically connected to the signal supply module, the major signal terminal set comprising a first side major signal terminal and a second side major signal terminal, wherein the first side major signal terminal comprises a first side major signal terminal joining structure, and the second side major signal terminal comprises a second side major signal terminal joining structure, wherein the first side major signal terminal joining structure is joined with the first side minor signal terminal, and the second side major signal terminal joining structure is joined with the second side minor signal terminal; wherein,
the major connector body is further mated with the major signal terminal set to respectively position the first side major signal terminal and the second side major signal terminal, such that the first side major signal terminal joining structure is located at the first major connector body side, and the second side major signal terminal joining structure is located at the second major connector body side; wherein,
for joining the minor connector with the major connector, the first side major signal terminal joining structure is allowed to join the first side minor signal terminal, and the second side major signal terminal joining structure is allowed to join the second side minor signal terminal, such that the first side major signal terminal is electrically connected to the first side minor signal terminal, and the second side major signal terminal is electrically connected to the second side minor signal terminal; and
the signal supply module is triggered by the trigger module to provide the first side terminal signal to the first side minor signal terminal through the first side major signal terminal, and to provide the second side terminal signal to the second side minor signal terminal through the second side major signal terminal.

6. The major connector of claim 5, wherein the time when the trigger module triggers the signal supply module is earlier than the time when the signal supply module provides the first side terminal signal and the second side terminal signal.

7. The major connector of claim 5, wherein the time when the minor signal terminal set is joined with the major signal terminal set is earlier than the time when the minor trigger component is joined with the major trigger component set.

8. The major connector of claim 7, wherein the time when the minor power terminal set is joined with the major power terminal set is earlier than the time when the minor signal terminal set is joined with the major signal terminal set.

9. The major connector of claim 5, wherein the major signal terminal set is located between the first side major power terminal and the second side major power terminal, and the major signal terminal set is located between the first side major trigger component and the second side major trigger component.

10. A connector assembly for being used with a power supply module and a trigger module, wherein the trigger module is configured to trigger the power supply module to provide a first side terminal power and a second side terminal power, and the connector assembly comprises:
a major connector comprising:
a major power terminal set electrically connected to the power supply module, the major power terminal set comprising a first side major power terminal and a second side major power terminal, wherein the first side major power terminal comprises a first side major power terminal joining structure, and the second side major power terminal comprises a second side major power terminal joining structure;
a major trigger component set electrically connected to the trigger module, the major trigger component set comprising a first side major trigger component and a second side major trigger component, wherein the first side major trigger component comprises a first side major trigger component joining structure, and the second side major trigger component comprises a second side major trigger component joining structure; and
a major connector body, which comprises a major connector body joining guiding structure, and has a first major connector body side and a second major connector body side respectively formed on two sides thereof, wherein the major connector body is mated with the major power terminal set and the major trigger component set to respectively set the first side major power terminal, the second side major power terminal, the first side major trigger component and the second side major trigger component in position, such that the first side major power terminal joining structure is located at the first major connector body side, the second side major power terminal joining structure is located at the second major connector body side, the first side major trigger component joining structure is located at the first major connector body side, and the second side major trigger component joining structure is located at the second major connector body side; and
a minor connector configured to be joined with the major connector, the minor connector comprising:
a minor power terminal set, which comprises a first side minor power terminal and a second side minor power terminal, wherein the first side minor power terminal comprises a first side minor power terminal joining structure, and the second side minor power terminal comprises a second side minor power terminal joining structure, wherein the first side minor power terminal joining structure is configured to be joined with the first side major power terminal joining structure, and the second side minor power terminal joining structure is configured to be joined with the second side major power terminal joining structure; and
a minor trigger component, which comprises a first side minor trigger component joining structure and a second side minor trigger component joining structure, wherein the first side minor trigger component joining structure is configured to be joined with the first side major trigger component joining structure, and the second side minor trigger component joining structure is configured to be joined with the second side major trigger component joining structure; wherein,
for joining the minor connector with the major connector, the major connector body joining guiding structure is configured to guide the minor power terminal set to join the major power terminal set and to guide the minor trigger component to join the major trigger component set, so as to allow the first side minor power terminal joining structure to be joined with the first side major power terminal joining structure, and allow the second side minor power terminal joining structure to be joined with the second side major power terminal joining structure, such that the first side major power terminal and the first side minor power terminal are electrically connected to each other, and the second side major power terminal and the second side minor power terminal are electrically connected to each other, and, the first side minor trigger component joining structure is joined with the first side major trigger component joining structure, and the second side minor trigger component joining structure is joined the second side major trigger component joining structure, such that the first side major trigger component, the second side major trigger component and the minor trigger component are electrically connected to each other to allow the power supply module to be triggered by the trigger module to provide the first side terminal power to the first side minor power terminal through the first side major power terminal and to provide the second side terminal power to the second side minor power terminal through the second side major power terminal.

11. The connector assembly of claim 10, wherein the minor trigger component is a conductive shell, and the first side major trigger component and the second side major trigger component are elastic conductive terminals that abut against the minor trigger component.

12. The connector assembly of claim 10, wherein the minor trigger component further comprises a minor trigger component joining retaining structure configured to contact the major connector body to keep the minor connector joined with the major connector.

13. The connector assembly of claim 10, wherein the first side major trigger component joining structure and the second side major trigger component joining structure are elastic arm joining structures.

14. The connector assembly of claim 10, wherein the first side minor trigger component joining structure and the second side minor trigger component joining structure are wall joining structures.

15. The connector assembly of claim 10, wherein the first side minor power terminal and the second side minor power terminal are blade-type conductive terminals, and the first side major power terminal and the second side major power terminal are clamping-type terminals.

16. The connector assembly of claim 10, wherein the minor power terminal set is located between the first side minor trigger component joining structure and the second side minor trigger component joining structure.

17. The connector assembly of claim 10, wherein,
the connector assembly is further configured to be used with a signal supply module, and the trigger module is further configured to trigger the signal supply module to provide a first side terminal signal and a second side terminal signal;
the major connector further comprises a major signal terminal set electrically connected to the signal supply module, the major signal terminal set comprising a first side major signal terminal and a second side major signal terminal, wherein the first side major signal terminal comprises a first side major signal terminal joining structure, and the second side major signal terminal comprises a second side major signal terminal joining structure; wherein the major connector body is further mated with the major signal terminal set to respectively position the first side major signal terminal and the second side major signal terminal, such that the first side major signal terminal joining structure is located at the first major connector body side, and the second side major signal terminal joining structure is located at the second major connector body side; and
the minor connector further comprises a minor signal terminal set, which comprises a first side minor signal terminal and a second side minor signal terminal, wherein the first side minor signal terminal comprises a first side minor signal terminal joining structure, and the second side minor signal terminal comprises a second side minor signal terminal joining structure, wherein the first side minor signal terminal joining structure is configured to be joined with the first side major signal terminal joining structure, and the second side minor signal terminal joining structure is configured to be joined with the second side major signal terminal joining structure; wherein,
for joining the minor connector with the major connector, the major connector body joining guiding structure is further configured to guide the minor signal terminal set to join the major signal terminal set, such that the first side minor signal terminal joining structure is joined with the first side major signal terminal joining structure, and the second side minor signal terminal joining structure is joined with the second side major signal terminal joining structure, so as to allow the first side major signal terminal and the first side minor signal terminal to be electrically connected to each other, and allow the second side major signal terminal and the second side minor signal terminal to be electrically connected to each other; and
with the first side major trigger component, the second side major trigger component and the minor trigger component being electrically connected to each other, the trigger module further triggers the signal supply module to provide the first side terminal signal to the first side minor signal terminal through the first side major signal terminal, and to provide the second side terminal signal to the second side minor signal terminal through the second side major signal terminal.

18. The connector assembly of claim 17, wherein the first side minor signal terminal and the second side minor signal terminal are blade-type conductive terminals, and the first side major signal terminal and the second side major signal terminal are clamping-type terminals.

19. The connector assembly of claim 17, wherein the minor signal terminal set is located between the first side minor power terminal and the second side minor power terminal, and the minor signal terminal set is located between the first side minor trigger component joining structure and the second side minor trigger component joining structure.

20. The connector assembly of claim 17, wherein the minor trigger component further comprises a minor trigger component joining guiding structure, wherein for joining the minor connector with the major connector, the minor trigger component joining guiding structure is configured to cooperate with the major connector body joining guiding structure to guide the minor power terminal set, the minor trigger component and the minor signal terminal set to respectively join the major power terminal set, the major trigger component set and the major signal terminal set.
